(19) United States
(12) Patent Application Publication
(10) Pub. No.: US 2005/0276085 A1
(43) Pub. Date: Dec. 15, 2005

(54) Current control for inductive weld loads

(76) Inventor: Jackie Laverne Winn, Raleigh, NC (US)

Correspondence Address: SQUARE D COMPANY;INTELLECTUAL PROPERTY DEPARTMENT, 1415 SOUTH ROSELLE ROAD, PALATINE, IL, 60067, US

(21) Appl. No.: 10/869,317

(22) Filed: Jun. 15, 2004

(51) Int. Cl. H02M 3/24

(52) U.S. Cl. 363/132

(57) ABSTRACT

According to an example embodiment of the present invention, a circuit arrangement controls a load current to an inductive weld load in a welding application with certain compensation for the slope of the current delivery to the inductive load, such that the average load current converges quickly to the selected command current without impacting the transient response. The circuit arrangement includes a user-engageable control adapted to specify a command current value for the inductive weld load and a current sensor adapted to measure an observed current value from instantaneous current pulses through the inductive weld load during a current supply operation that is responsive to the specified command current value. The circuit arrangement additionally includes a current-mode control circuit adapted to generate a compensation current value based on the command current value and the observed current value, a reference current value based on the command current value and the compensation current value, and at least one gate signal for controlling the load current based on the observed current value and the reference current value.

### FIELD OF THE INVENTION

The present invention is directed to controlling line power derived currents through electrical loads that are inductive in nature using pulse width modulation.

### BACKGROUND

The control of certain electrical loads that are inductive in nature, such as found in industrial machinery, requires controlling the delivery of line power to the electrical load. The controlled delivery of line power achieves certain control objectives, such as the heat delivery profile for direct current resistance welders.

Generally, the inductance of a load that is inductive in nature introduces a phase lag in a control circuit for the inductive load. The phase lag necessitates limiting the control loop bandwidth of the control circuit to avoid or limit overshoot. The limited control loop bandwidth impacts the response time of the control circuit, impacting the transient response of the control circuit.

Control for inductive loads is needed that limits overshoot without impacting the transient response. These and other considerations have presented challenges to controlling line power derived currents through electrical loads that are inductive in nature.

### SUMMARY

The present invention is directed to overcoming the above-mentioned challenges and others related to the types of devices and applications discussed above and in other applications. The present invention is exemplified in a number of implementations and applications, some of which are summarized below.

According to an example embodiment of the present invention, a circuit arrangement controls a load current, derived from a power line, to an inductive weld load in a weld application. The circuit arrangement includes a user-engageable control adapted to specify a command current value for the inductive weld load and a current sensor adapted to measure an observed current value from instantaneous current pulses through the inductive weld load during a current supply operation that is responsive to the specified command current value. The circuit arrangement additionally includes a current-mode control circuit adapted to generate a compensation current value based on the command current value and the observed current value, a reference current value based on the command current value and the compensation current value, and at least one gate signal for controlling the load current based on the observed current value and the reference current value.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention in connection with the accompanying drawings, in which:

FIG. 1 is a block diagram for controlling a load current, according to an example embodiment of the present invention;

FIG. 2 is a block diagram for controlling a welding current, according to another example embodiment of the present invention;

FIG. 3 is a block diagram of a current controller, according to an example embodiment of the present invention;

FIG. 4 is a block diagram of a current controller using a digital signal processor, according to another example embodiment of the present invention;

FIG. 5 is a waveform diagram illustrating the control of a load current, according to an example embodiment of the present invention; and

FIGS. 6A and 6B are flow diagrams of a process for current control, according to an example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of current control applications for inductive loads, and has been found to be particularly useful for current control in welding applications. For instance, example embodiments of the present invention are applicable for direct current resistance welding applications. While the present invention is not necessarily limited to such applications, various aspects of the invention may be appreciated through a discussion of various examples using this context.

According to an example embodiment of the present invention, the current that is delivered using pulse width modulation (PWM) from a power line to an inductive load is measured. The measured current is compared to a reference that is a sum of a selected command current and a scaled compensation value. The compensation value may initially have a value of zero, such that the reference initially corresponds to a selected command current. During pulses of the PWM in which the measured current does not reach the value of the reference, as may occur for the initial pulses after the selected value of the command current is modified, the compensation value is not modified to diminish or eliminate overshoot in the transient response. For pulses of the PWM in which the measured current does reach the value of the reference, the compensation value is modified using a gated integration, which adds the scaled difference between the command current and the measured average value to the compensation value during current delivery for these pulses. The compensation value acts to compensate for the slope of the current delivery to the inductive load, such that the average load current converges quickly to the selected command current without impacting the transient response.

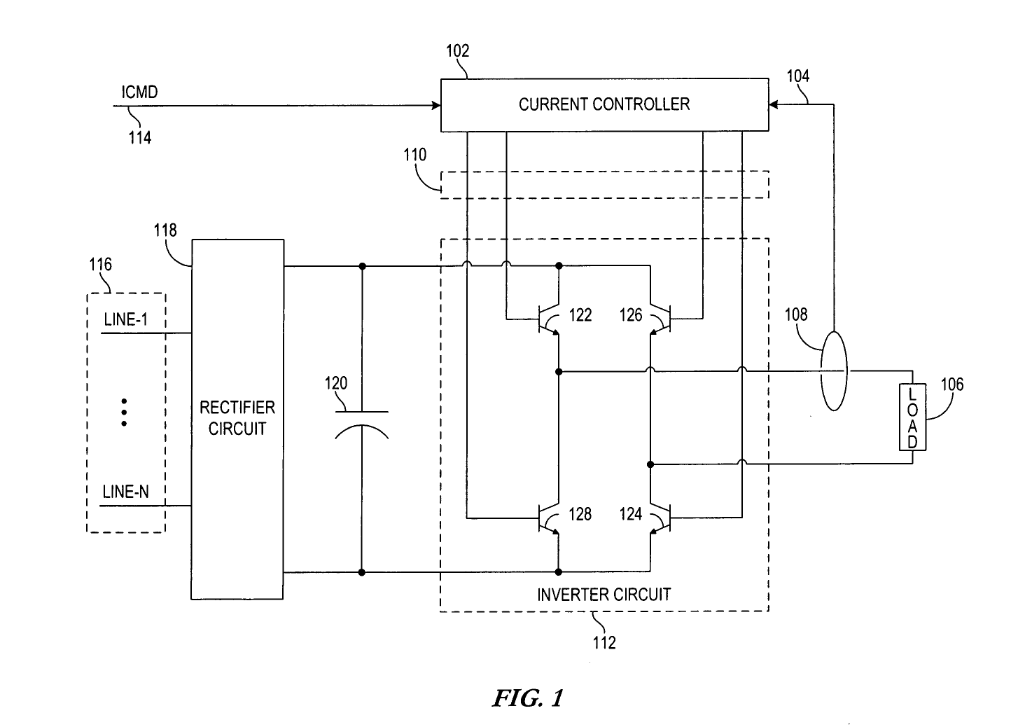

FIG. 1 is a block diagram for controlling a load current, according to an example embodiment of the present invention. A current controller 102 may observe the value on line 104 of the load current of an inductive load 106 with a current sensor 108. The current controller 102 may generate gate signals on lines 110 for an inverter circuit 112 based on the observed load current on line 104 and the desired command current on line 114, as is later discussed in detail. The command current value on line 114 may be provided by a user and may have a value that varies with time. The gate signals on lines 110 may cause the inverter circuit 112 to control the current supplied to load 106.

Line power on lines 116 may be rectified by rectifier circuit 118 and filtered by capacitor bank 120 to produce direct current (DC) power for the inverter circuit 112. Example line power on lines 116 include two-phase power with two lines, three-phase power with three lines, and two lines of a three-phase power mains.

Generally the current controller 102 may generate gate signals 110 that couple the DC power across the load 106 in one direction by turning on gated devices 122 and 124 or in the reverse direction by turning on gated devices 126 and 128. Alternating current may be supplied to the load 106 with a controlled duty cycle by the inverter circuit 112. To prevent a short-circuit of the DC power through gated devices 122 and 128, or through gated devices 126 and 124, current controller 102 may generate gate signals 110 that turn off all gated devices 122, 124, 126, and 128 for a commutation interval before turning on either 122 and 124, or turning on 126 and 128. Gated devices 122, 124, 126, and 128 may be devices such as bipolar transistors, insulated gate bipolar transistors, or MOSFETS.

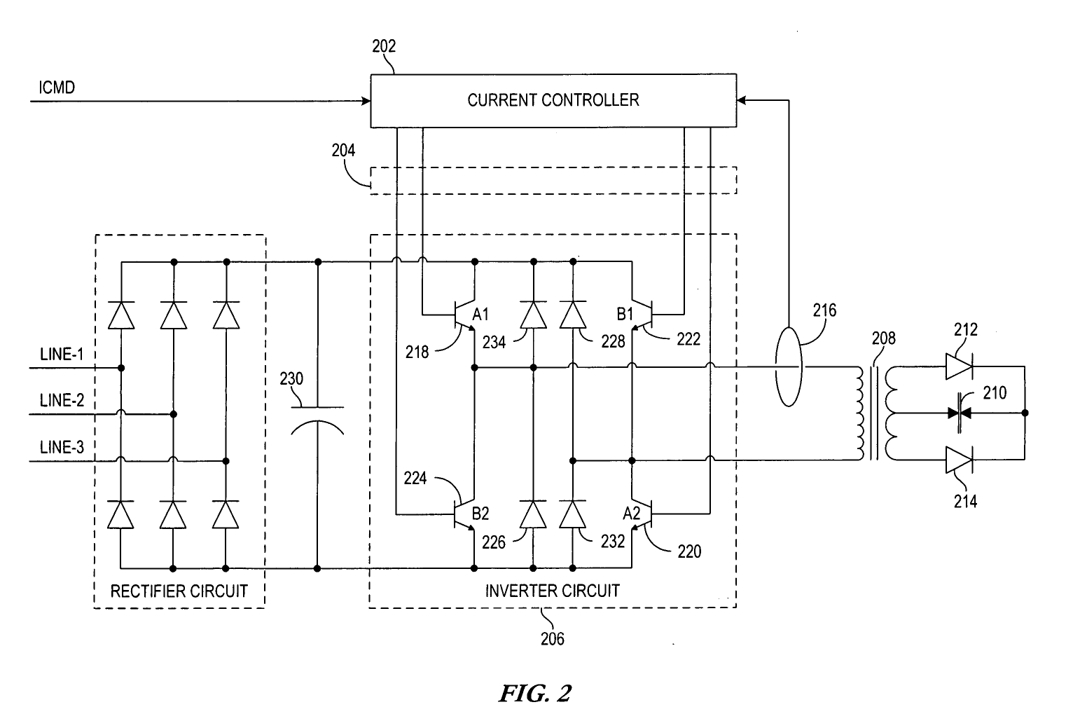

FIG. 2 is a block diagram for controlling a welding current, according to another example embodiment of the present invention. Current controller 202 may generate gate signals 204 to cause inverter circuit 206 to supply alternating current with a controlled duty cycle to the primary of transformer 208. The alternating current supplied to the primary of transformer 208 by inverter circuit 206 is multiplied by a turns ratio of the transformer 208 to produce the secondary current through the welding load 210. A typical turns ratio is in the range of 40-80. A center tap of the secondary of transformer 208 may be coupled to one terminal of the welding load 210 and the outer taps of the secondary may both be coupled to the other terminal of the welding load 210 through respective rectifiers 212 and 214. The rectifiers 212 and 214 rectify the alternating secondary current from transformer 208 to produce DC for DC resistance welding.

The current through the welding load 210 may be observed indirectly by measuring the current through the primary of transformer 208 with current sensor 216. A typical transformer has an excitation current of 1% or less of the rated transformer rating, such that using the primary current to measure the welding current adds minimal error to the measured value of the weld current. In another embodiment, the current may be observed on the secondary of transformer 208. Examples for current sensor 216 include a current transformer, a Hall effect sensor, and a voltage measurement across a precision resistance.

The current controller 202 may generate gate signals 204 that alternate enabling gated devices 218 and 220 with enabling gated device 222 and 224 as is later discussed in detail. The welding load 210 may be inductive due to the loop inductance of the wiring from the transformer 208 through the welding load 210. Typically, the voltage drop across a lumped inductance component for the welding load 210 is greater than the voltage drop across a series lumped resistance component for the welding load 210, such that the current through the welding load 210 ramps approximately linearly with time when gated devices 218 and 220 are enabled or when gated devices 222 and 224 are enabled.

Between alternately enabling gated devices 218 and 220 and enabling gated devices 222 and 224, all gated devices 218, 220, 222, and 224 are disabled for at least a commutation interval. All gated devices 218, 220, 222, and 224 may be disabled for longer than the commutation interval to control the duty cycle of the pulse width modulation (PWM) and hence the current through the welding load.

While all gated devices 218, 220, 222, and 224 are disabled after an enabling of gated devices 218 and 220, current continues to flow in a free-wheeling manner in the primary of transformer 208 due to primary inductance and leakage inductance of the transformer, and the continued flow of primary current may forward bias the anti-parallel rectifiers 226 and 228 and may return energy to the DC supply by potentially charging capacitor bank 230. Similarly anti-parallel rectifiers 232 and 234 may forward bias while all gated devices 218, 220, 222, and 224 are disabled after an enabling of gated devices 222 and 224. While all gated devices 218, 220, 222, and 224 are disabled, the secondary current will free-wheel through rectifiers 212 and 214 essentially short circuiting the secondary of transformer 208. Typically, free-wheeling interval of the primary current is very short time relative to the free-wheeling interval of the secondary current; for example, where the primary free-wheeling interval may be 10 microseconds, the secondary free-wheel interval may be 10 milliseconds.

The current through the welding load 210 may decay approximately linearly with time while all gated devices 218, 220, 222, and 224 are disabled. Typically, the decay rate of the current through the welding load 210 while all gated devices 218, 220, 222, and 224 are disabled is greater than the ramp rate of the current through the welding load 210 while gated devices 218 and 220 are enabled or while gated devices 222 and 224 are enabled. However, the decay rate may be less than the ramp rate depending upon factors such as the load voltage.

The transformer 208 may have a rating, such as a primary voltage rating, which limits the voltage that may be applied to the transformer 208. Exceeding the rating of transformer 208 may cause saturation of the magnetic core of the transformer 208 resulting in excessive primary current. When the DC supply voltage (across capacitor bank 230) exceeds the rating of the transformer 208, the duty cycle for enabling gated devices 218 and 220 or enabling gated devices 222 and 224 may be limited, for example by the ratio of the transformer rating to the present DC supply voltage, thereby limiting the volt-seconds applied to the primary of the transformer 208 to the rating of the transformer 208.

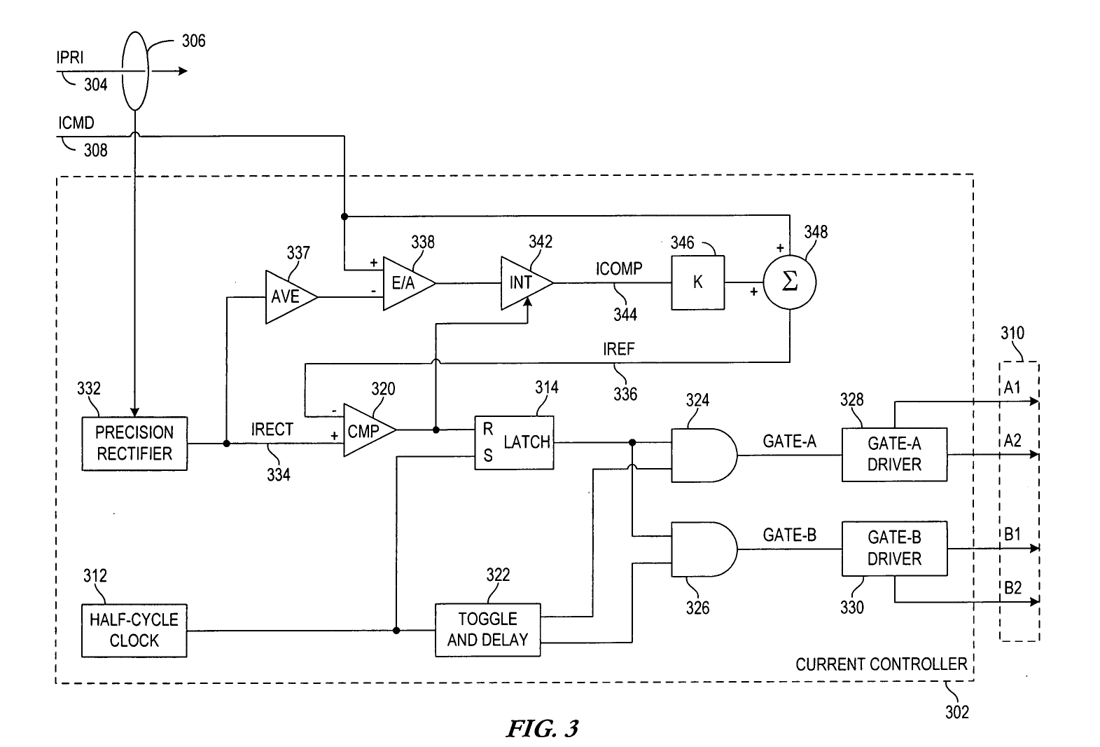

FIG. 3 is a block diagram of a current controller 302, according to an example embodiment of the present invention. The current controller 302 may measure the welding current by measuring the primary current on line 304 via current sensor 306. A command current value on line 308 may represent a user selected welding current and is a control input to the current controller 302. The current controller 302 operates to control the welding current to match the potentially time varying command current value on line 308 by controlling the duty cycle of an inverter circuit via gate signals 310.

The cycle time of the current controller 302 is controlled by half-cycle clock 312. The frequency of the half-cycle clock 312 may be governed by a rating, such as a frequency rating, of an associated welding transformer. A typical welding transformer frequency rating is 1000 to 1200 Hz, such that the half-cycle clock 312 frequency is 2000 to 2400 Hz. The duty cycle latch 314 determines the portion of a half cycle in which power is applied to a welding load. The half-cycle clock 312 sets the duty cycle latch 314 at the beginning of a period of the half-cycle clock 312.

The toggle and delay block 322 alternately enables AND gate 324 and AND gate 326, following a delay, to route alternate duty cycle latch 314 pulse outputs to either gate-A driver 328 or gate-B driver 330. The gate drivers 328 and 330 contain pulse shaping and level shifting circuitry to generate the gate signals 310.

The delay of block 322 specifies the maximum duty cycle for power delivery to the welding load. In one embodiment, the delay of block 322 may include a commutation delay value given by the worst case time required for the gated devices to turn off. In another embodiment, feedback from the gated devices may indicate the actual time when the gated devices have turned off to provide the commutation delay. A rating, such as a primary voltage rating, of an associated welding transformer may limit the voltage that may be applied to the transformer. In one embodiment, the delay of block 322 may include a de-rating delay given by the fraction of the half-cycle clock 312 period given by the ratio of the transformer rating to the worst case DC supply voltage. In another embodiment, the actual DC supply voltage may be measured and similarly used to calculate the de-rating delay.

The measured welding current value is rectified by a precision rectifier 332 to generate a rectified value on line 334 representing a rectified welding current. The precision rectifier 332 may be arranged to eliminate the voltage drop during forward bias associated with the diodes used to rectify the current measurement signal.

Comparator 320 compares the rectified value on line 334 with a reference value on line 336. The reference value on line 336 initially may have a value in correspondence with the command current value 308. When the rectified value on line 334 exceeds the reference value on line 336, duty cycle latch 314 is reset via comparator 320, thereby ending a half cycle of delivery of welding current. Thus, duty cycle latch 314 is reset within a period of half-cycle clock 312 when the rectified value on line 334 reaches the reference value on line 336.

An averaging circuit 337 generates an average value for the rectified current value on line 334. An error amplifier 338 generates an output amplifying the difference between the average value for the rectified current value on line 334 and the selected current value on line 308. A gated integrator 342 integrates the error amplifier 338 output during power delivery to the welding load when comparator 320 indicates the rectified value on line 334 has reached the reference value on line 336 in the half cycle. Thus, overshoot is diminished or eliminated by the slope compensation output on line 344 not including a compensation component for half-cycles, such as initial current ramp half-cycles, having a rectified value on line 334 that does not reach the reference value on line 336. The selection of compensation loop response may be selected without affecting overshoot during any such initial current ramp half-cycles. The compensation output 334 may be scaled by the compensation loop response constant K 346 and added by adder 348 to the command current value on line 308 to generate the reference value. A typical value for constant K 346 may be 1/16 or 1/32.

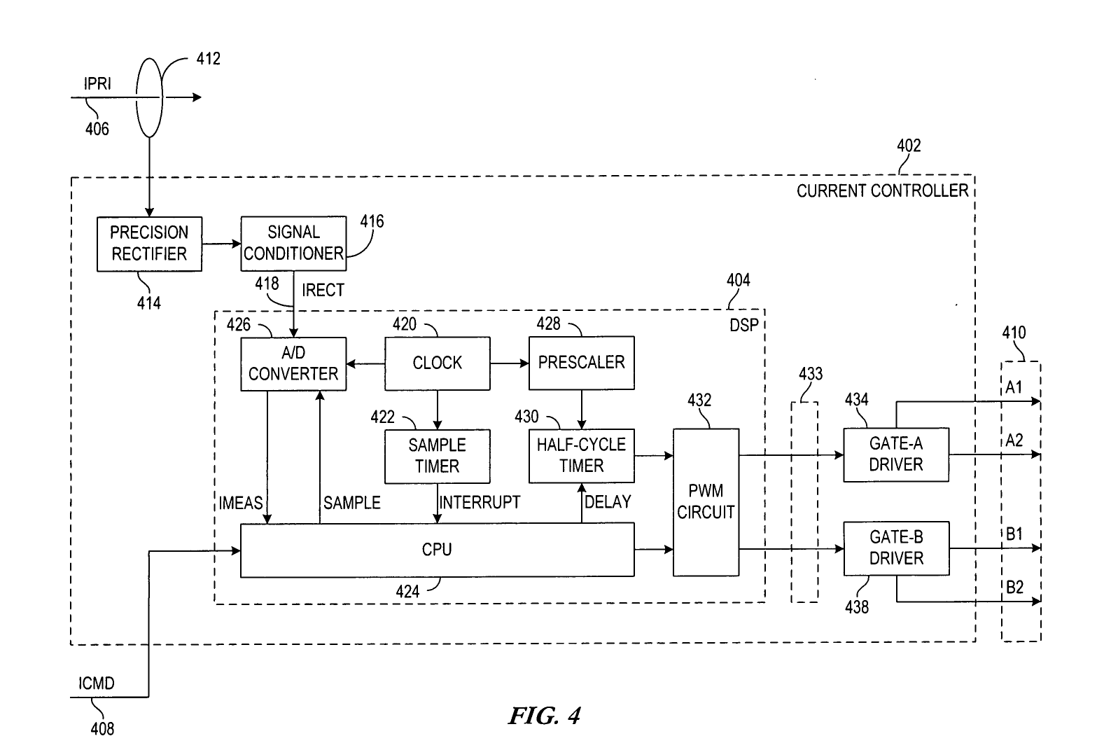

FIG. 4 is a block diagram of a current controller 402 using a digital signal processor 404, according to another example embodiment of the present invention. Current controller 402 may operate to match the welding current deduced from the primary current on line 406 of an associated welding transformer with the selected command current on line 408 by controlling the pulse width modulation (PWM) of gate outputs 410.

The welding current may be measured by measuring primary current on line 406 with current sensor 412. The value from current sensor 412 is rectified by precision rectifier 414 and filtered by signal conditioner 416 to generate a value on line 418 representing the rectified welding current. Signal conditioner 416 may provide filter functions such as noise filtering and anti-aliasing filtering. In one embodiment, signal conditioner 416 can be a 2-pole Bessel low-pass filter with a cut-off frequency of 25 k Hz.

A clock 420 can govern timing for DSP 404, and in one embodiment, clock 420 is a 40 MHz clock. A hardware counter of DPS 404 may provide sample timer 422 which in one embodiment counts to a limit of 521-clocks to generate a sample interrupt to CPU 424 at a rate of approximately 76800 Hz. For each sample interrupt from sample timer 422, CPU 424 can obtain the digital value for rectified welding current on line 418 from analog-to-digital converter 426, and then begin another analog-to-digital conversion by analog-to-digital converter 426.

Prescaler 428 and half-cycle timer 430 may determine the duration of a half cycle of the welding current. In one embodiment, half-cycle timer 430 may count to the same limit as sample timer 422 with the limit of prescaler 428 determining the number of samples in a half-cycle. In one embodiment, 32-samples are taken every half cycle, so prescaler 428 counts to a limit of 32-samples and the half-cycle timer 430 has a frequency of approximately 2400 Hz.

CPU 424 may calculate and provide a commutation delay value to PWM circuit 432 with each half cycle possibly having a separately calculated delay value in one embodiment. The commutation delay value may provide a time delay allowing the gated devices of an inverter circuit to turn off and/or to limit the duty cycle to prevent exceeding the ratings of an associated welding transformer, as previously discussed. PWM circuit 432 enables the appropriate PWM output 433 when the count value in half-cycle timer 430 is greater than the delay value. When the count value in half-cycle timer 430 reaches the limit value, half-cycle timer 430 may roll over to a value of zero, and thus disable PWM output 433. The CPU 424 generates an enable for PWM circuit 432 which alternately enables Gate-A or Gate-B or neither depending upon whether a current has been commanded.

CPU 424 may generate another enable for PWM circuit 432, which adjusts a PWM circuit 432 pulse width to control the welding current inferred from primary current on line 406 to match the selected command current on line 408, as is later discussed in detail. The PWM circuit 432 alternates outputs between the gate-A driver 434 and the gate-B driver 438 which each perform pulse shaping and level shifting functions to generate the gate signals 410.

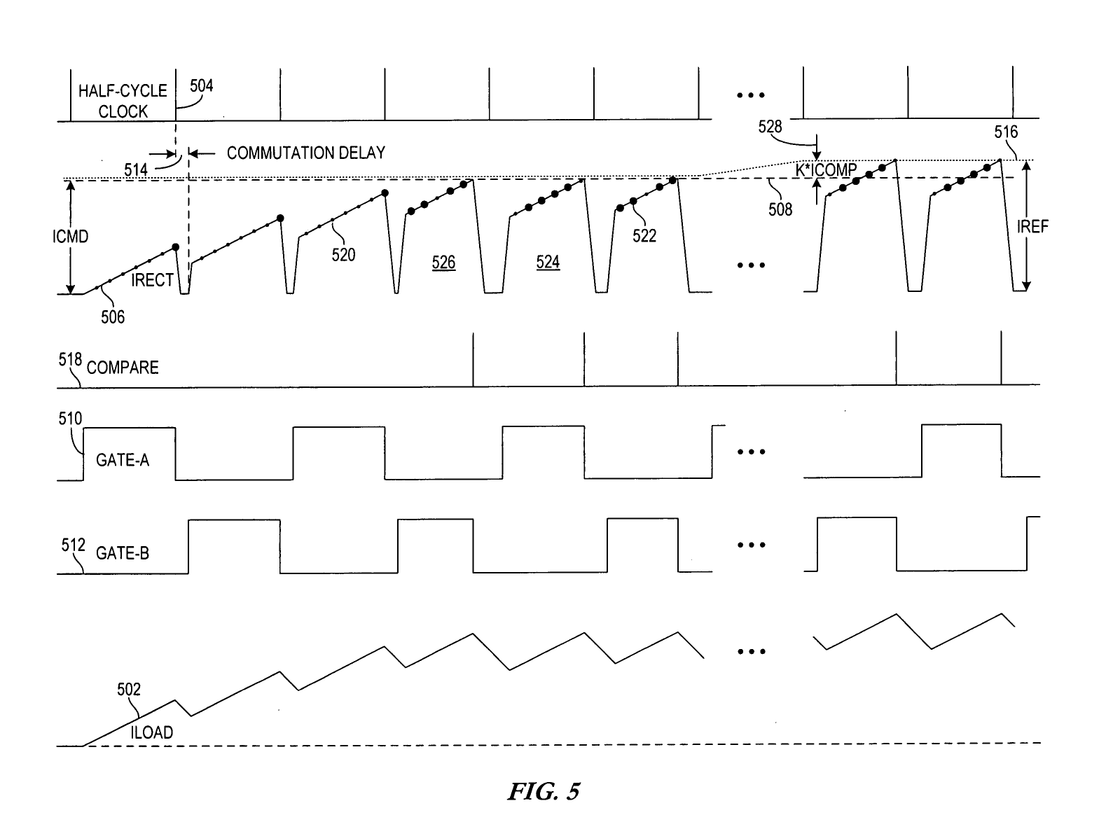

FIG. 5 is a waveform diagram illustrating the control of a load current 502, according to an example embodiment of the present invention. The waveforms have cycle timing governed by half-cycle clock 504, which generates a short pulse at the boundary of every half-cycle period. It will be appreciated that half-cycle clock 504 may have a longer pulse, such as a square wave, and the rising edge, the falling edge, or both the rising and falling edges of the half-cycle clock 504 may be used to control circuit timing. It will be appreciated that half-cycle clock 504 may be generated by a limit comparison of a counter driven by a reference clock, such as a crystal oscillator.

Waveform 506 represents the rectified load current with a selected load current having a superimposed command current waveform 508 shown as a constant value for clarity of the discussion. It will be appreciated that the command current waveform 508 may have a value that varies over time. For example, a profile for a particular weld of a welding load may initially ramp to a medium current value for the purpose of burning off any insulating deposits on the welding materials, jump to a low current value to allow the burn-off heat to spread to a condition substantially independent from the burn-off behavior, and finally jump to a high current value to melt and join the welding materials.

Waveform 510 for gate-A and waveform 512 for gate-B alternate the gating load current 502 in alternating directions with PWM in each half-cycle period. When load current 502 is required, each gate waveform 510 and 512 has rising edges a commutation delay 514 after the beginning of a half-cycle clock 504 period. The commutation delay 514 can be a delay to allow gated devices of an associated inverter to turn off, and/or a delay to limit the maximum duty cycle of the PWM.

In a half-cycle clock 504 period when the rectified load waveform 506 does not reach a superimposed reference waveform 516, which may be initially equal to the command current waveform 508, a pulse is not generated on the PWM waveform 518 and the gate pulse is terminated with the end of the half-cycle clock 504 period, as is shown for the first three half-cycles. In a typical embodiment of a typical welding load, three half-cycles may be required for the rectified load waveform 506 to reach the reference waveform 516. When the rectified load waveform 506 does reach the reference waveform 516 before the end of a half-cycle period, a pulse is generated on the PWM waveform 518 substantially coincident with the moment when the rectified load waveform 506 reaches the reference current waveform 516, as shown for the half-cycles after the first three half-cycles, including half cycles 524 and 526. A pulse of the PWM waveform 518 causes a falling edge on the appropriate one of the gate waveforms 510 and 512, ending power delivery to the load for the corresponding half-cycle.

For an inductive load where the time constant for the inductive load is greater than the half-cycle time, the rectified load waveform 506 may ramp approximately linearly during the gating of power delivery to the inductive load. The rectified load waveform 506 may be sampled during the gating of power delivery as shown for small dots 520 and large dots 522. The samples of large dots 522 may be used to compensate for the slope of the rectified load waveform 506 by calculating an average value for the rectified load waveform 506 during the conduction interval.

In one embodiment, a middle four samples 522 during gated power delivery from each half-cycle are used to calculate the average value for the rectified load waveform 506 in the half-cycle. The number of samples having a value that is greater than a specific threshold during gated power delivery in each half-cycle may be counted. The number of such samples in a half-cycle may be an even number or an odd number. When the number is even, as in half-cycle 524, the middle four of the samples 522 may be used to calculate the average value for the rectified load waveform 506 in half-cycle 524. When the number is odd, as in half-cycle 526, to expedite averaging by using a division by four, the two of the samples 522 on either side of the middle one of the samples may be used to calculate the average value for the rectified load waveform 506 in half-cycle 526. If the number of samples is less than or equal to four then the last sample is used as the average value.

In one embodiment, the average value for the rectified load waveform 506 in each half-cycle may be subtracted from the average value for the selected load current with command waveform 508 for the half-cycle to generate an error value. The error values may be accumulated to produce a compensation value, thereby performing a gated integration of the difference between the rectified load waveform 506 and the command waveform 508, with the integration gated during current delivery to the inductive load and further gated to accumulate error values only for half cycles in which the rectified load waveform 506 reaches the reference waveform 516. The reference waveform 516 may be generated as the sum of the command waveform 508 and a scaled value 528 for the compensation value.

The scaled compensation value 528 acts to make the average value during current delivery for the rectified load current 506 approximately equal to the command waveform 508, thereby compensating for the slope during power delivery of the load current 502. The reference waveform 516 is not modified in half cycles in which the rectified load waveform 506 does not reach the reference waveform 516, preventing slope compensation during these ramping half cycles, thereby diminishing or eliminating overshoot of load current 502 during the ramping half cycles. The scaling constant K is generally a value less than one, selected to determine control loop response during half cycles other than the ramping half cycles. The value for the scaling constant K may be 1/32 in one embodiment and 1/16 in another embodiment.

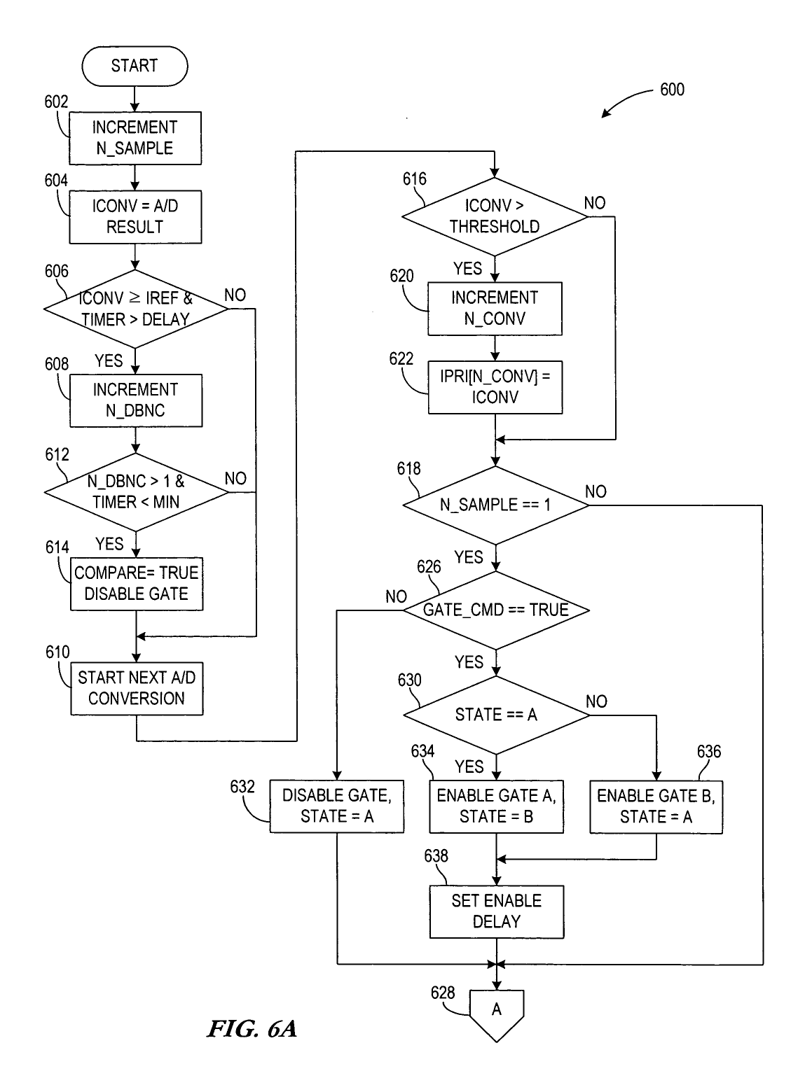

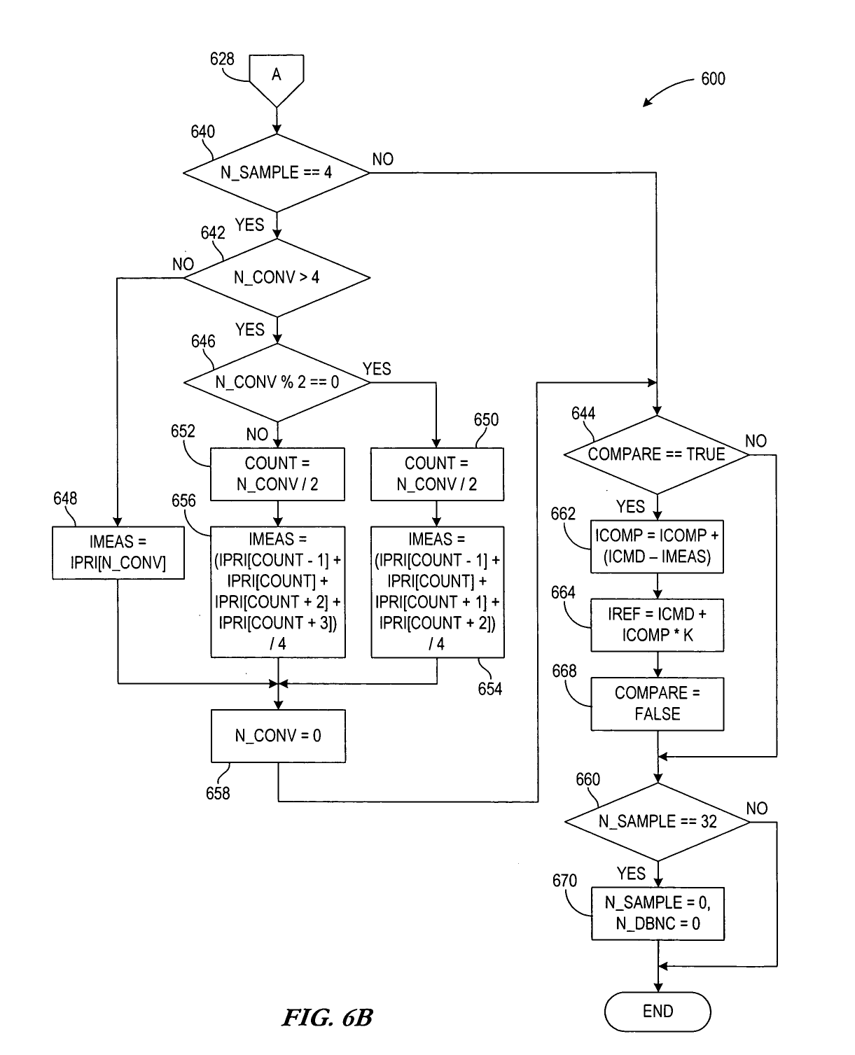

FIGS. 6A and 6B are flow diagrams of a process 600 for current control, according to an example embodiment of the present invention. In various embodiments of the invention, the process 600 may be executed by a processor, such as a digital signal processor, to process samples representative of the load current that is controlled by process 600. Process 600 may control the load current to match a selected command value that may vary in time. The process 600 may be an interrupt service routine invoked by an interrupt generated by a sample timer establishing the sample period.

Process 600 begins by incrementing the number of samples in the half-cycle at step 602. Stopping current delivery at the end of a half cycle may be performed by enable logic external to process 600. At step 604, the value of a sample that represents the load current is obtained from an analog-to-digital converter. At decision 606, when the sample reaches or exceeds a reference value during the delivery of load current following a commutation delay, process 600 proceeds to step 608, otherwise process 600 proceeds to step 610. A debounce count of the number of samples reaching or exceeding the reference value is incremented at step 608. At decision 612, the debounce count is checked to ensure that two samples have reached or exceeded the reference value and at least a minimum current delivery interval has been met, and then process 600 proceeds to step 614 where current delivery is stopped by disabling gate signals, otherwise process 600 proceeds to step 610. The next analog-to-digital conversion may be launched at step 610.

Next, process 600 may store the sample representing the load current in a storage array. Only samples greater than a threshold value are stored, such that decision 616 bypasses sample storage for samples not greater than the threshold by proceeding to decision 618. For samples greater than the threshold, step 620 increments the sample count and step 622 stores the sample in the storage array.

For the first sample of a half-cycle, process 600 proceeds from decision 618 to decision 626 to prepare enabling of load current, otherwise process 600 proceeds from decision 618 to sheet connector 628. At decision 626, when load current has been enabled external to process 600, process 600 proceeds to decision 630, otherwise process 600 proceeds to step 632. At step 632, the load current is stopped by disabling gate signals and gate-A is selected to be the next gate signal to be enabled.

At decision 630, process 600 proceeds to step 634 when a state variable indicates gate-A is the next gate signal to be enabled, and otherwise when gate-B is the next gate signal to be enabled, process 600 proceeds to step 636. At step 634, gate-A is enabled to deliver positive load current after the commutation delay set at step 638, and gate-B is selected to be the next gate signal to be enabled. At step 636, gate-B is enabled to deliver negative load current after the commutation delay set at step 638, and gate-A is selected to be the next gate signal to be enabled. A commutation delay value is set at step 638 to enable either gate-A or gate-B as appropriate after the delay interval.

Sheet connector 628 of FIG. 6A connects process 600 to sheet connector 628 of FIG. 6B.

For the fourth sample of a half-cycle, process 600 proceeds from decision 640 to decision 642 to calculate the average load current for the prior half-cycle, otherwise process 600 proceeds from decision 640 to decision 644. At decision 642, process 600 proceeds to the average calculation at step 646 when more than four samples are available in the storage array, otherwise process 600 bypasses the average calculation by proceeding to step 648, where the average is given the value of the last stored sample. At decision 646, process 600 proceeds to step 650 when the number of stored samples is even, otherwise process 600 proceeds to step 652 when the number of stored samples is odd.

The middle sample is calculated at both step 650 and 652. At step 654, the four middle samples from the storage array are summed and then divided by four to calculate the average load current. At step 656, the two samples before the middle sample and the two samples after the middle sample are summed and then divided by four to calculate the average load current. At step 658, the storage array is effectively cleared by setting the number of stored samples to zero.

Process 600 bypasses updating the reference current at decision 644 by proceeding to decision 660 when the load current did not reach the reference value at step 614, thereby preventing updating the reference current with a compensation value that might cause load current overshoot, otherwise process 600 proceeds to step 662. At step 662, the compensation value is updated by accumulating the difference between the selected command value and the average load current. The reference value is calculated as the sum of the selected command value and a scaling of the compensation value at step 664. A flag indicating the load current has reached the reference value is cleared at step 668.

For the last sample of a half-cycle having sample number 32 in one embodiment, process 600 proceeds from decision 660 to decision 670, otherwise process 600 bypasses decision 670. At step 670, the sample number of a half-cycle is reinitialized to zero for the next half-cycle and the debounce count is initialized to zero.

In addition, a variety of other ways of controlling line power derived currents through electrical loads that are inductive in nature can be performed using the approaches discussed herein.

The various embodiments described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to altering the pulse width modulation to provide direct current pulses instead of alternating current pulses. Such modifications and changes do not depart from the true spirit and scope of the present invention that is set forth in the following claims.

1. A circuit arrangement for controlling a load current, derived from a power line, to an inductive weld load in a weld application, comprising:
a user-engageable control adapted to specify a command current value for the inductive weld load;
a current sensor adapted to measure an observed current value from instantaneous current pulses through the inductive weld load during a current supply operation that is responsive to the specified command current value; and
a current-mode control circuit adapted to generate
a compensation current value based on the command current value and the observed current value,
a reference current value based on the command current value and the compensation current value, and
at least one gate signal for controlling the load current based on the observed current value and the reference current value.

2. The circuit arrangement of claim 1, wherein the compensation current value is based on a determination that the command current value is not accurate for the weld application, and the current-mode control circuit uses the reference current value as a reference level for gating the load current for the weld application.

3. The circuit arrangement of claim 1, wherein said at least one gate signal is a pulse-width modulated (PWM) signal.

4. The circuit arrangement of claim 3, further including a circuit that is adapted to control the load current supplied from the power line in response to said at least one gate signal.

5. A circuit arrangement of claim 4, wherein the current-mode control circuit is further adapted to generate
the compensation current value based on a difference between the command current value and the observed current value,
the reference current value based on a sum between the command current value and the compensation current value, and
the at least one gate signal for controlling the load current based on a relation between the observed current value and the reference current value.

6. The circuit arrangement of claim 5, wherein the current-mode control circuit is adapted to determine a difference value as a function of a difference in respective magnitudes between the command current value and the observed current value.

7. The circuit arrangement of claim 6, wherein the current-mode control circuit is adapted to mathematically process the difference value to provide the compensation current value.

8. The circuit arrangement of claim 7, wherein the current-mode control circuit is adapted to calculate a gated integration of the difference value to provide the compensation current value.

9. The circuit arrangement of claim 8, wherein the current-mode control circuit is adapted to generate the reference current value from a sum between the magnitude of the command current value and a scaling of the magnitude of the compensation current value.

10. The circuit arrangement of claim 9, wherein the current-mode control circuit is adapted to generate a value for said at least one gate signal to control supplying the load current derived from the power line while the magnitude of the observed current value is less than a magnitude of the reference current value.

11. The circuit arrangement of claim 10, wherein the current-mode control circuit is adapted to calculate the gated integration during a period corresponding to said at least one gate signal for which the magnitude of the observed current value becomes at least the magnitude of the reference current value during the period.

12. A circuit arrangement for controlling a load current, derived from a power line, to an inductive weld load in a weld application, comprising:
means for specifying a command current value for the inductive weld load;
means for measuring an observed current value from instantaneous current pulses through the inductive weld load during a current supply operation that is responsive to the specified command current value;
means for generating a compensation current value based on a difference between the command current value and the observed current value;
means for generating a reference current value based on a sum between the command current value and the compensation current value; and
means for producing at least one gate signal that controls the load current based on a relation between the observed current value and the reference current value.

13. A method for controlling a load current, derived from a power line, to an inductive weld load in a weld application, comprising:
specifying a command current value for the inductive weld load;
measuring an observed current value from instantaneous current pulses through the inductive weld load during a current supply operation that is responsive to the specified command current value;
generating a compensation current value based on a difference between the command current value and the observed current value;
generating a reference current value based on a sum between the command current value and the compensation current value; and
producing at least one gate signal that controls the load current based on a relation between the observed current value and the reference current value.

14. The method of claim 13, wherein the step of generating the compensation current value includes determining a difference value as a function of the difference between the command current value and the observed current value.

15. The method of claim 14, wherein the step of generating the compensation current value further includes mathematically processing the difference value to provide the compensation current value.

16. The method of claim 15, wherein the step of mathematically processing the difference value includes calculating a gated integration of the difference value.

17. The method of claim 16, wherein the step of generating the reference current value includes generating the reference current value from a sum between the command current value and a scaling of the compensation current value.

18. The method of claim 17, wherein the step of producing said at least one gate signal includes producing a value for said at least one gate signal to control supplying the load current derived from the power line while the observed current value is less than the reference current value.

19. The method of claim 18, wherein the step of calculating the gated integration includes integrating the difference value during a period corresponding to said at least one gate signal, wherein the observed current value becomes at least the reference current value during the period.

20. The method of claim 13, wherein the step of producing said at least one gate signal further includes inhibiting said at least one gate signal during a commutation interval.

21. The method of claim 13, wherein the step of producing said at least one gate signal further includes limiting the duty cycle of said at least one gate signal.

22. The method of claim 13, wherein the inductive weld load is a welding circuit.

23. The method of claim 22, wherein the inductive weld load is a circuit for direct current resistance welding.

24. The method of claim 13, wherein the step of specifying of the command current value includes specifying the time variation of the command current value.
